(19) United States
(12) Patent Application Publication
(10) Pub. No.: US 2011/0138332 A1
(43) Pub. Date: Jun. 9, 2011

(54) INFORMATION PROCESSING DEVICE AND METHOD FOR CONTROLLING INFORMATION PROCESSING DEVICE

(76) Inventor: Miho MIYAGAWA, Kanagawa-ken (JP)

(21) Appl. No.: 12/949,403

(22) Filed: Nov. 18, 2010

(30) Foreign Application Priority Data
Dec. 3, 2009 (JP) 2009-275607

(51) Int. Cl. G06F 3/048

(52) U.S. Cl. 715/835

(57) ABSTRACT

The information processing device includes an icon displaying member for displaying multiple icons in a screen thereof to show set contents of functions or conditions of the device using the icons; a selecting member for selecting at least one of the multiple icons displayed in the screen; and a controller for allowing the icon displaying member to display in the screen at least first information on the selected icon other than the name thereof and second information on a second icon belonging to a category to which the selected icon belongs, and for changing the set content of a function of the device indicated by the selected icon to a content of a function indicated by the second icon when at least the first-selected icon and the second icon are displayed in the screen and the second icon is selected by the selecting member.

### BACKGROUND OF THE INVENTION

1. Field of the Invention

The present invention relates to an information processing device, and to a method for controlling an information processing device.

2. Description of the Related Art

Recently, with technology advancement, imaging devices such as digital cameras have been improved so as to have higher performance and function. Many of these imaging devices display information such as set values and conditions concerning shooting conditions using icons so that the information is visible to users. In addition, with improvement of performance and function of these imaging devices, the number of functions settable by users increases, and therefore the amount of the information on shooting conditions increases, resulting in increase of the number of icons displaying the information.

As mentioned above, the function of icons is to display information such as set values and conditions concerning shooting conditions. However, as the number of the icons displaying the information increases, it becomes difficult for users to understand the meaning of the icons. Particularly when a person used an imaging device, which is commonly used by several persons, icons strange to the person are often displayed in the imaging device after another person uses the imaging device. In this case, the person has to read the instruction manual of the imaging device to know the meanings of the icons and the way to change the set values or to delete the icons. Such an operation is troublesome for the person.

In attempting to solve the problem, an information processing device is proposed in which multiple icons are displayed in a screen of the device while the screen is separated into multiple areas, and the name of an icon in one of the multiple areas selected by a user is displayed in the screen.

When a person uses such an information processing device, there is a case in which the person knows the name of the icon in the selected area but cannot understand the meaning and contents of the selected icon and whether or not to change the set condition of the function indicated by the icon.

For these reasons, there is a need for a user-friendly information processing device, which can display information on an icon or an advice about the function indicated by the icon in the screen thereof so that users can know the meaning of the icon and/or the set value and conditions of the function indicated by the icon and in which users can change the settings of the function indicated by the icon when the information on the icon is displayed in the screen thereof.

### SUMMARY

This patent specification describes a novel information processing device, one embodiment of which includes an icon displaying member configured to display multiple icons in a screen thereof to show set contents of the functions or conditions of the information processing device using the icons; a selecting member configured to select at least one of the multiple icons displayed in the screen; a controller configured to allow the icon displaying member to display in the screen at least first information on the selected icon other than the name thereof and second information on a second icon belonging to a category to which the selected icon belongs, and configured to change a set content of a function of the information processing device indicated by the selected icon to a content of a function indicated by the second icon when at least the first-selected icon and the second icon are displayed in the screen and the second icon is selected by the selecting member.

This patent specification further describes a novel controlling method for controlling an information processing device, one embodiment of which includes displaying multiple icons in a screen of the information processing device to show set contents of the functions or conditions of the information processing device; selecting at least one of the multiple icons displayed in the screen; displaying in the screen at least first information on the selected icon other than the name thereof and second information on a second icon belonging to a category to which the selected icon belongs; and changing a set content of a function of the device indicated by the selected icon to a content indicated by the second icon by selecting the second icon in the screen displaying at least the first-selected icon and the second icon.

### BRIEF DESCRIPTION OF THE DRAWINGS

Amore complete appreciation of aspects of the invention and many of the attendant advantage thereof will be readily obtained as the same become better understood by reference to the following detailed description when considered in connection with the accompanying drawings, wherein:

FIG. 1 is a schematic view illustrating the backside of a digital camera as one example of the information processing device of the present invention;

FIG. 2 is a schematic view illustrating the upper side of the digital camera illustrated in FIG. 1;

FIG. 3 is a schematic view illustrating the foreside of the digital camera illustrated in FIG. 1;

FIG. 4 is a block diagram illustrating an example of the information processing device of the present invention;

FIG. 5 is a block diagram illustrating the detailed configuration of the digital camera illustrated in FIG. 4;

FIG. 6A is a view illustrating a list of icons of the digital camera each representing an icon category;

FIG. 6B is a table illustrating the names of the icon categories of the digital camera;

FIG. 7 illustrates an image displayed in a screen of the digital camera achieving a still image shooting mode;

FIG. 8 illustrates an information displaying icon selection screen image displayed in the screen of the digital camera;

FIG. 9A illustrates a screen image of the digital camera displaying information on flash mode category icons; and

FIG. 9B illustrates a screen image of the digital camera displaying information on battery level category icons.

### DESCRIPTION OF THE PREFERRED EMBODIMENTS

The present invention will be described by reference to drawings.

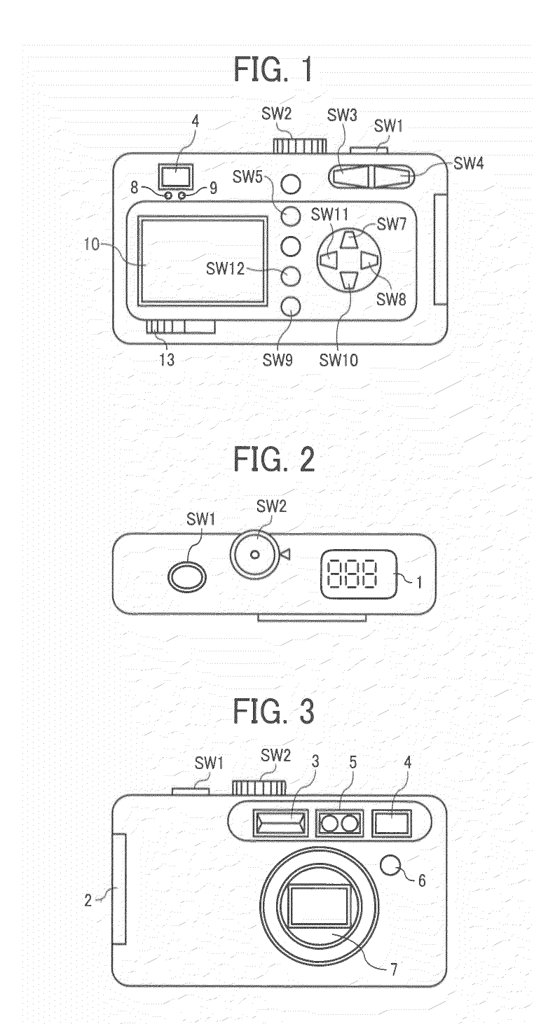

FIGS. 1-3 illustrate the backside, upper side and foreside of a digital camera as an example of the information processing device of the present invention.

Referring to FIG. 2, the digital camera has a release shutter button SW1, a mode dial button SW2 used for switching the mode of the camera such as shooting modes and reproducing modes, a sub-LCD 1 configured to display the number of remaining exposure (i.e., remaining storage capacity) and battery end.

Referring to FIG. 1, the digital camera further has an AF LED 8 configured to notify users that the object is focused in an auto-focusing mode, a strobe LED 9 configured to notify users that the battery is charged, an optical finder 4, zoom switches SW3 and SW4 used for performing zoom-in operation (“Telescope” mode) or a zoom-out operation (“Wide” mode), a power switch 13 used for switching on or off the main body of the digital camera, a LCD monitor 10 serving as an icon displaying member configured to display a monitoring view or a setting view used for setting, four-direction keys SW7, SW8, SW10 and SW11, a self-timer SW5, and an OK key SW12. The four-direction keys and the OK key serve as a selecting member.

Referring to FIG. 3, the digital camera further has a cover 2 configured to cover a battery and a SD card serving as an external memory, which are set to the main body of the digital camera, a camera body unit 7 configured to house lenses therein, a remote-control light sensor 6, a distance measuring unit 5 configured to measure a distance to an object, and a strobe 3. Reference numeral SW9 denotes a MENU key.

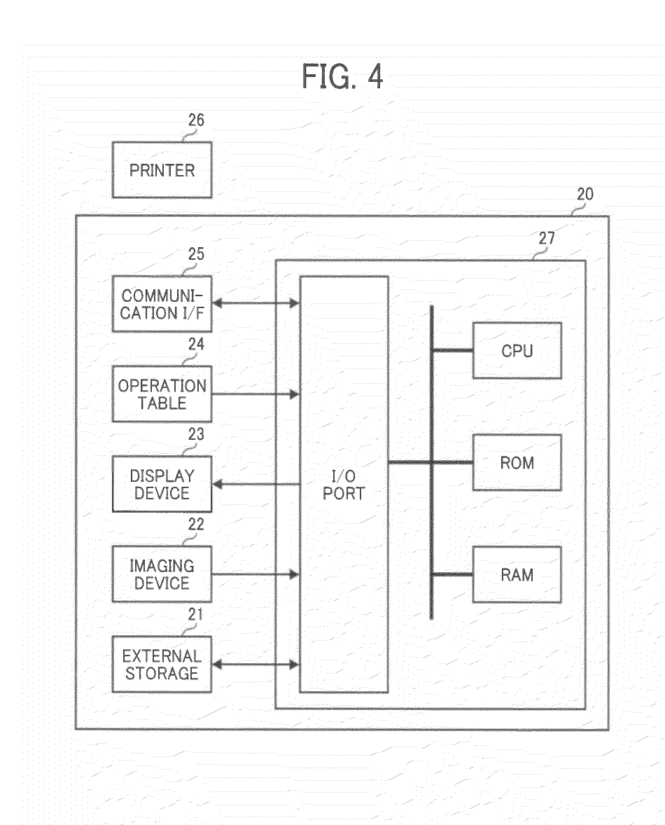

FIG. 4 is a block diagram illustrating an example of the information processing device of the present invention. In the information processing device, a digital camera 20 can communicate with a printer 26 using a USB or a blue tooth. The digital camera 20 has an external storage 21 configured to store information such as a flash memory, an imaging device 22 serving as an image information inputting portion and including a CCD, an AD converter, etc., a display device 23 configured to display various kinds of information, an operation table 24 used for external information inputting, a communication interface (I/F) 25 configured to control the interface between the digital camera and the printer 26, and a controller 27 configured to control the entire digital camera. The controller 27 is constituted of a common microcomputer including devices such as CPUs, ROMs, RAMs, input/output ports (I/O port) and a bus line connecting the devices.

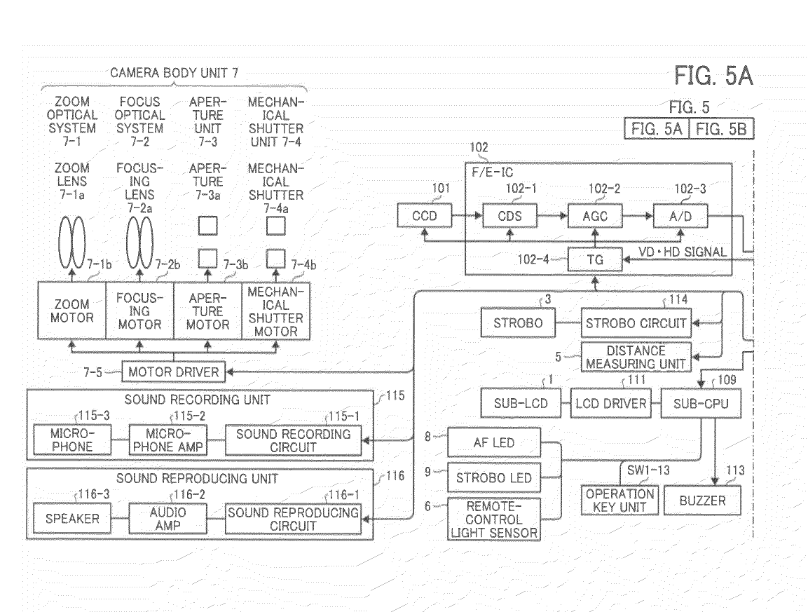

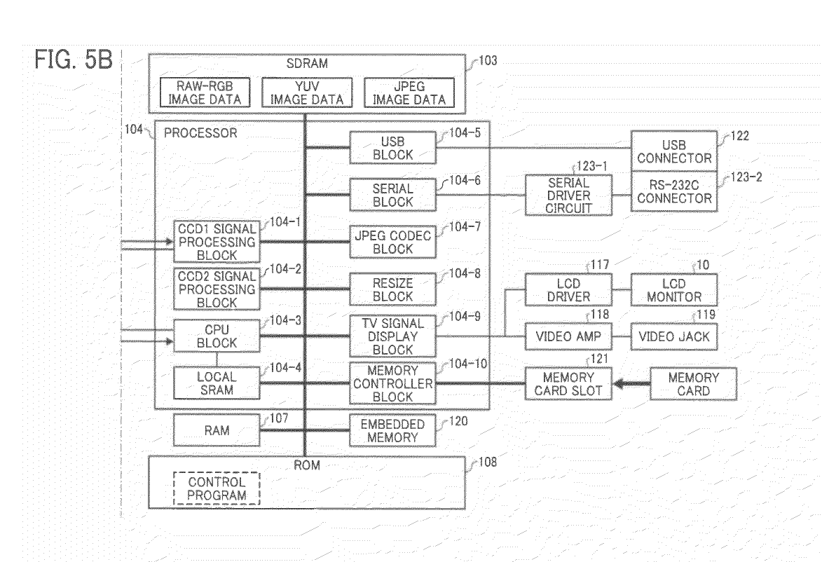

FIG. 5 is a block diagram illustrating the detailed configuration of the digital camera illustrated in FIG. 4.

Next, the operation of the digital camera will be described by reference to FIGS. 1 and 5.

The camera body unit 7 has a zoom optical system 7-1 including a zoom lens 7-1a and a zoom motor 7-1b, a focus optical system 7-2 including a focusing lens 7-2a and a focus motor 7-2b, an aperture unit 7-3 including an aperture 7-3a and an aperture motor 7-3b, a mechanical shutter unit 7-4 including a mechanical shutter 7-4a and a shutter motor 7-4b, and a motor driver 7-5 configured to drive the motors 7-1b, 7-2b, 7-3b and 7-4b. The motor driver 7-5 is driven by an order from a CPU block 104-3 of a digital still camera processor 104 mentioned below according to an input operation using a remote control light sensor 6 or a key of an operation key unit such as the keys SW1-SW12.

A ROM 108 stores control program and parameters for use in controlling, which are written by a code readable by the CPU block 104-3. When the digital camera is switched, a main memory (not shown) is loaded with the program, and the CPU block 104-3 controls the operations of the members of the digital camera according to the program while temporarily storing data necessary for controlling in a RAM 107 and a local SRAM 104-4 in the digital still camera processor 104 mentioned below. By using a flash ROM for the ROM 108, it becomes possible to change the control program and parameters for controlling, thereby easily making it possible to upgrade the function of the program.

A CCD 101 is a solid-state image sensing device for subjecting an optical image to photoelectric conversion, and a front-end IC (F/E-IC) 102 includes a CDS 102-1 configured to perform correlated double sampling for removing image noises, an AGC 102-2 configured to perform automatic gain control, an analog-digital (A/D) converter 102-3 configured to perform digital signal conversion, and a timing generator (TG) 102-4 which is supplied with a vertical synchronization signal (hereinafter VD) and a horizontal synchronization signal (hereinafter HD) from a CCD1 control block 104-1 to generate timing signals for driving the CCD 101 and the F/E-IC 102.

In this regard, the camera body unit 7, CCD 101 and F/E-IC serve as an imaging member.

The digital still camera processor 104 includes the CCD1 control block 104-1 configured to perform white balance setting and gamma setting on the data output from the CCD 101 through the F/E-IC 102 while supplying a VD signal and a HD signal as mentioned above, a CCD2 control block 104-2 configured to perform brightness data conversion and color difference data conversion by performing a filtering processing, the CPU block 104-3 configured to control the operations of the above-mentioned devices, the local SRAM 104-4 configured to temporarily store the above-mentioned data used for controlling, a USB block 104-5 configured to perform USE communication with an external device such as a personal computer, a serial block 104-6 configured to perform serial communication with an external device such as a personal computer, a JPEG CODEC block 104-7 configured to perform JPEG compression/expansion, a RESIZE block 104-8 configured to scale image data to a desired size by performing an interpolation processing, a TV signal display block configured to convert image data to video signals to display the image on a screen of an external device such as a LCD monitor or a television, and a memory card block 104-10 configured to control a memory card for use in recording image data of a shot image.

A SRAM 103 temporarily stores image data when the image data are subjected to the above-mentioned processings in the digital still camera processor 104. Specific examples of the image data include RAW-RGB image data obtained when the CCD1 signal processing block 104-1 performs white balance setting and gamma setting on the image data sent from the CCD 101 through the F/E-IC 102, YUV image data obtained when the CCD2 control block 104-2 performs the brightness data/color difference data conversion, and JPEG image data obtained by performing the JPEG compression processing in the JPEG CODEC block 104-7.

A memory card slot 121 is a slot through which a detachable memory card is attached to the digital camera.

An internal memory 120 is a memory configured to store image data of a shot image even when a memory card is not attached to the memory card slot 121.

A LCD driver 117 is a drive circuit for driving a LCD monitor 10 mentioned below, which also has a function of converting a video signal output from the TV signal display block 104-9 to a signal for displaying the image on the screen of the LCD monitor 10.

The LCD monitor 10 is used for watching the conditions of an object before shooting, confirming the shot image, displaying an image stored in the internal memory 120 or the memory card, etc.

A video AMP 118 is an amplifier for subjecting a video signal output from the TV signal display block 104-9 to 75Ω impedance conversion, and a video jack 119 is a jack for connecting the digital camera with an external display device such as a TV.

A USB connector 122 is a connector for subjecting the digital camera to USE connection with an external device such as a personal computer.

A serial driving circuit 123-1 is a circuit for subjecting a signal output from the serial block 104-6 to voltage conversion to perform serial communication with an external device such as a personal computer. A RS-232 connector 123-2 is a connector for performing serial connection with an external device such as a personal computer.

A sub-CPU 109 is a CPU, which is a chip containing a ROM/RAM, and inputs as operation information a signal output from the key units SW1-SW12 and the remote-control light sensor 6 to the CPU block 104-3 while converting the information on conditions of the camera output from the CPU block 104-3 to control signals to be output to the sub-LCD 1, the AF LED 8, the strobe LED 9 and a buzzer 113.

The sub-LCD 1 is a display for displaying information such as maximum number of shooting, and a LCD driver 111 is a driving circuit for driving the sub-LCD 1 according to a signal output from the sub-CPU 109.

The AF LED 8 is a LCD for displaying the focusing condition of the camera in shooting, and the strobe LED 9 is a LED for displaying the charging condition of the strobe. In this regard, the AF LED 8 and the strobe LED 9 can be used for another application such as display of accessing to a memory card.

The operation keys SW1-SW12 are key circuits to be operated by users, and the remote-control light sensor 6 is configured to receive signals from a remote-control which is operated by users.

A sound recording unit 115 includes a microphone 115-3 to which a sound signal is input, a microphone AMP 115-2 configured to amplify the input sound signal, and a sound recording circuit 115-1 configured to record the amplified sound signal.

A sound reproducing unit 116 includes a sound reproducing circuit 116-1 configured to convert a recorded signal to a signal to be reproduced by a speaker 116-3, an audio AMP 116-2 configured to amplify the thus-converted sound signal to drive the speaker, and the speaker 116-3 configured to output the sound signal as a sound.

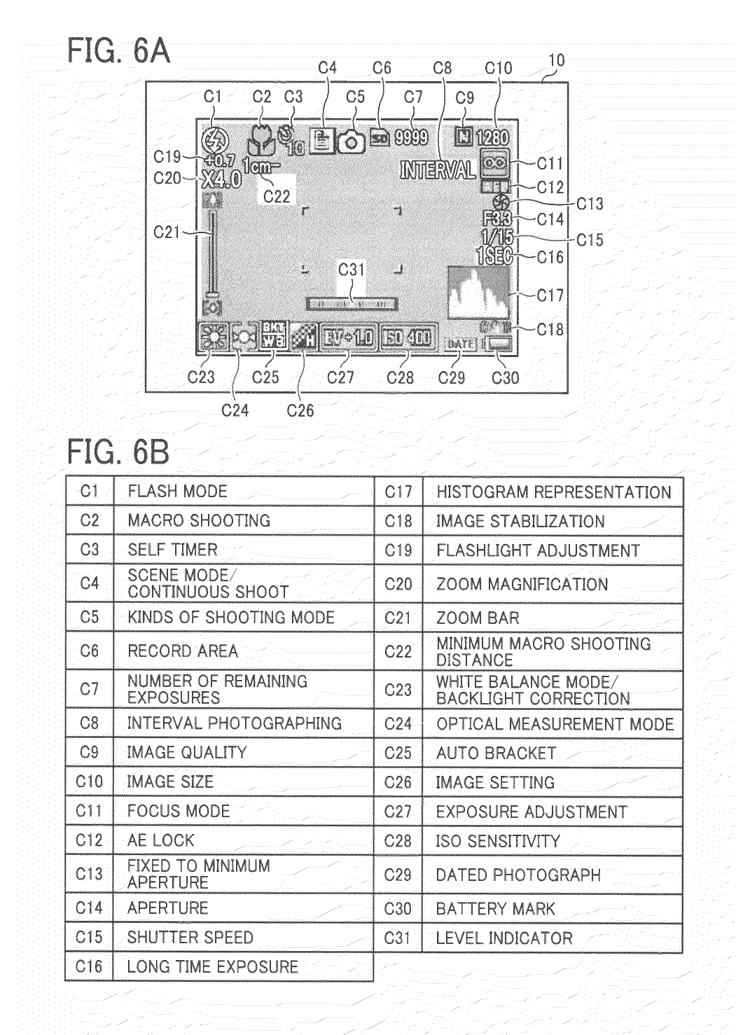

FIG. 6A is a view illustrating a list of category representing icons, i.e., a list of icons C1-C31, which can be displayed in the LCD monitor 10 in a shootable state of the digital camera. In real shooting, whether or not these icons are displayed is determined depending on the setting and conditions of the digital camera. In addition, there is a case in which another icon belonging to the same category is displayed instead of a category representing icon. For example, the icon C1 displayed in FIG. 6 represents a flash mode category and means a mode that flash is not emitted, but the icon may be replaced with another icon belonging to the flash mode category such as a forcible flashing icon depending on the setting of the digital camera.

FIG. 6B is a table illustrating the names of the icon categories of the digital camera, i.e., a correspondence table showing the relation between the numbers C1-C31 and the names of the icon categories of the digital camera.

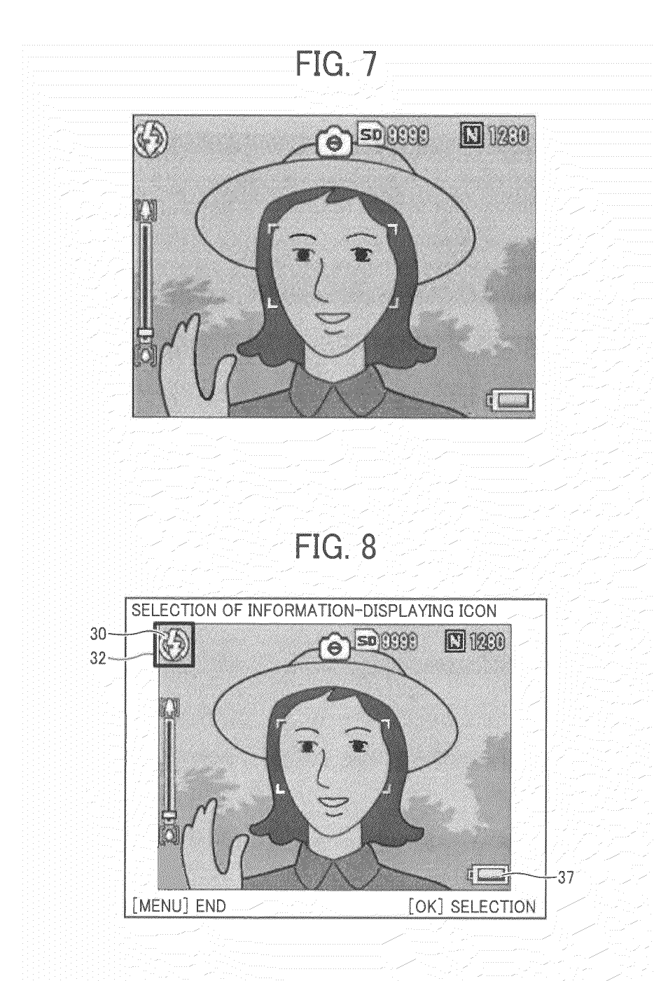

FIG. 7 illustrates an example of an image displayed in the LCD monitor 10 when the digital camera achieves a still image shooting mode, i.e., an image monitored when the digital camera is in the shootable state. In the image illustrated in FIG. 7, icons indicating the conditions or set values of each of the categories of the flash mode, shooting mode, record area, number of remaining exposures, image quality, image size, zoom bar, and battery level are displayed. In this regard, the displayed icons may be different depending on the setting and conditions of the digital camera, namely the icons may be replaced with other icons belonging to the respective categories.

FIG. 8 is a view illustrating an information displaying icon selection screen image of the digital camera. In the image illustrated in FIG. 8, an icon 30 indicating the flash mode is selected to display information on the category. When a user wishes to know the set values or advices about setting of the categories indicated by the icons in the screen image illustrated in FIG. 7, the user pushes the MENU key SW9 for a relatively long period of time so that the image displayed in the LCD monitor 10 is changed to the image (i.e., an information displaying icon selection screen image of the digital camera) illustrated in FIG. 8. The method for the icon selection is not limited thereto, and the icon selection may be performed by a method of pushing a special button provided on the digital camera or another method.

In the icon selection screen image illustrated in FIG. 8, the flash mode icon 30 is surrounded by a frame 32. In this regard, at a time in which the image displayed in the LCD monitor 10 is changed to the icon selection screen image, the frame 32 surrounds an uppermost and leftmost icon. The position of the frame 32 can be changed by operating the four-direction keys SW7, SW8, SW10 and SW11. When the MENU key SW9 is pushed in the information displaying icon selection screen image illustrated in FIG. 8, the screen is returned to the still image shooting mode screen image illustrated in FIG. 7. When the OK key SW12 is pushed in the icon selection screen image illustrated in FIG. 8, the screen image is changed to a screen image displaying information on the category indicated by the icon surrounded by the frame 32. The data of each icon information displaying screen image are fixed and stored in the ROM 108.

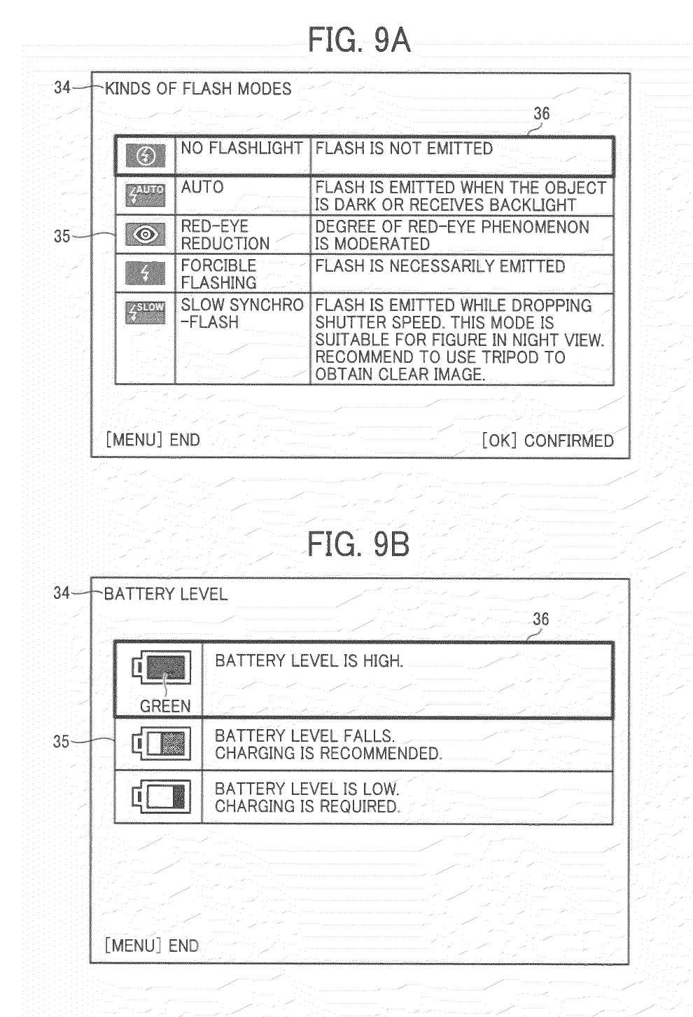

FIGS. 9A and 9B illustrate examples of the icon information displaying screen image. In FIGS. 9A and 9B, reference numeral 34 denotes the name of the category of the selected icon, i.e., one of the names of the categories listed in FIG. 6B, and reference numeral 35 denotes a table showing information on the selected category such as comments on kinds of the icons belonging to the category, names of the icons, set values, and setting methods. Thus, the information on the selected icon is displayed in the LCD monitor 10.

When the OK key SW12 is pushed while the flash mode category icon 30 is surrounded by the frame 32 in the information displaying icon selection screen image illustrated in FIG. 8, a screen image illustrated in FIG. 9A, which is the flash mode category icon information displaying image stored in the ROM 108, is displayed in the LCD monitor 10. When the OK key SW12 is pushed while another category icon is surrounded by the frame 32 in the information displaying icon selection screen image illustrated in FIG. 8, the corresponding category icon information displaying screen image stored in the ROM 108 is displayed in the LCD monitor 10.

In the screen image illustrated in FIG. 9A in which the information on the flash mode category icon is displayed, “kinds of flash modes” are illustrated at an upper portion of the screen. In addition, several flash mode icons are illustrated in the first row of the table 35, meanings of the icons are described in the second row of the table, and details of the icons and advices are described in the third row of the table.

In the flash mode category icon information screen image illustrated in FIG. 9A, the first column (i.e., “NO FLASHLIGHT” column) is surrounded by a frame 36. This is because the flash mode category icon in the still image shooting mode screen image illustrated in FIG. 7 is the “NO FLASHLIGHT” icon, i.e., the flash mode is set to the “NO FLASHLIGHT” mode. If the flash mode is set to another mode (for example, a “FORCIBLE FLASHING” mode), the corresponding column (the fourth (“FORCIBLE FLASHING”) column) of the table 35 in the screen image illustrated in FIG. 9A is surrounded by the frame 36. Since the information on the set flash mode (for example, “NO FLASHLIGHT” mode) is stored in the RAM 107, the column of the table 35 corresponding to the set flash mode (“NO FLASHLIGHT” mode column) is surrounded by the frame 36 by reference to the information. The frame 36 can be moved to another column of the table 35 by operating the up-and-down keys SW7 and SW10.

In the flash mode category icon information screen image illustrated in FIG. 9A, when the MENU key SW9 is pushed, the screen is changed to the icon selection screen image illustrated in FIG. 8. If the OK key SW12 is pushed in the flash mode category icon information screen image illustrated in FIG. 9A, the flash mode is changed so as to be set to the flash mode surrounded by the frame 36, and then the screen image is changed to the icon selection screen image illustrated in FIG. 8.

When shooting is performed while the object receives backlight, the user can notice the comments in the second column (AUTO mode) of the table 35 such that flash is emitted when the object is dark or receives backlight. Therefore, the user can set the flash mode to the “AUTO” mode without question.

In the icon selection screen image illustrated in FIG. 8, the category can be changed from the category surrounded by the frame 32 (i.e., the flash mode category in FIG. 8) to a battery level category by moving the frame to the battery mark icon 37 by operating the four-direction keys SW7, SW8, SW10 and SW11, followed by pushing the OK key SW12. In this case, the screen image illustrated in FIG. 8 is changed to the battery level information displaying screen image illustrated in FIG. 9B.

In the battery level information displaying screen image illustrated in FIG. 9B, the name 34 of the category, “BATTERY LEVEL”, is displayed on an upper portion of the screen image. In addition, several battery level icons indicating different battery levels are illustrated in the first row of the table 35 in the screen illustrated in FIG. 9B, and details of the icons and advices are described in the second row of the table.

In the battery level information displaying screen image illustrated in FIG. 9B, the first column is surrounded by the frame 36. This means that the battery level of the digital camera is high. When the battery level is different from the high level, the corresponding battery mark icon is surrounded by the frame 36. The information on the battery level is stored in the RAM 107 while updated. By reference to the information, the corresponding battery level icon is surrounded by the frame 36 in the screen image illustrated in FIG. 9B. Unlike the flash mode screen image illustrated in FIG. 9A, the frame 36 cannot be moved by operating the keys SW7, SW8, SW10 and SW11 in the battery level information displaying screen image illustrated in FIG. 9B.

By selecting one of the icons in the icon selection screen image illustrated in FIG. 8, the image can be changed to another screen image, which is predetermined and is stored in the ROM 108. Whether or not the frame 36 can be moved in the icon information displaying screen image illustrated in FIGS. 9A and 9B is predetermined depending on the data stored in the ROM 108.

In the battery level information displaying screen image illustrated in FIG. 9B, when the MENU key SW9 is pushed, the screen image is changed to the icon selection screen image illustrated in FIG. 8. In this regard, it is possible that, by pushing the MENU key SW12 or the OK key SW12 in the screen image illustrated in FIG. 9A or 9B, the screen image is changed to the still image shooting mode screen image illustrated in FIG. 7.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2009-275607, filed on Dec. 3, 2009, the entire contents of which are herein incorporated by reference.

What is claimed is:

1. An information processing device comprising:
an icon displaying member configured to display multiple icons in a screen thereof to show set contents of functions or conditions of the information processing device using the icons;
a selecting member configured to select at least one of the multiple icons displayed in the screen; and
a controller configured to allow the icon displaying member to display in the screen at least first information on the selected icon other than the name of the selected icon and second information on a second icon belonging to a category to which the selected icon belongs, and configured to change a set content of a function of the information processing device indicated by the selected icon to a content of a function indicated by the second icon when at least the first-selected icon and the second icon are displayed in the screen and the second icon is selected by the selecting member.

2. The information processing device according to claim 1, wherein the first information displayed in the screen includes at least one of description of the set contents of the functions or conditions of the information processing device, and an advice for users about setting of the information processing device.

3. The information processing device according to claim 1, further comprising:
an imaging member configured to take an optical image while converting the optical image to digital image signals, wherein the controller processes the digital image signals to display the optical image in the screen.

4. A method for controlling an information processing device, comprising:
displaying multiple icons in a screen of the information processing device to show set contents of functions or conditions of the information processing device;
selecting at least one of the multiple icons displayed in the screen;
displaying in the screen at least first information on the selected icon other than a name thereof and second information on a second icon belonging to a category to which the selected icon belongs; and
changing a set content of a function of the information processing device indicated by the selected icon to a content indicated by the second icon by selecting the second icon in the screen displaying at least the first-selected icon and the second icon.

5. The method according to claim 4, wherein the first information displayed in the screen includes at least one of description of the set contents of the functions or conditions of the information processing device, and an advice for users about setting of the information processing device.
